(19) United States
(12) Patent Application Publication
(10) Pub. No.: US 2026/0046966 A1
(43) Pub. Date: Feb. 12, 2026

(54) TECHNIQUES FOR COLLISION HANDLING IN GATEWAY SESSIONS IN WIRELESS COMMUNICATIONS

(71) Applicant: Microsoft Technology Licensing, LLC, Redmond, WA (US)

(72) Inventors: Piyush JAIN, Bengaluru (IN); Sreenivas Reddy Komati Reddy, Acton, MA (US)

(21) Appl. No.: 18/798,570

(22) Filed: Aug. 8, 2024

(51) Int. Cl. H04W 76/18; H04W 76/19

(52) U.S. Cl. CPC H04W 76/18; H04W 76/19

(57) ABSTRACT

Described are examples for modifying a packet data network (PDN) gateway used for a session in wireless communications where the PDN gateway can receive, for a mobility management entity (MME) or evolved packet data gateway (ePDG), a request to restore an existing session with the first PDN gateway, receive, from a database, and based on attempting to restore the existing session for the MME or ePDG, a read lock failure based on a restoration of the existing session established for the MME or ePDG and a second PDN gateway, and send, for the MME or ePDG, a rejection message in response to the request, where the rejection message includes a cause code indicating to restore the existing session with the second PDN gateway. Other examples relate to the MME or ePDG receiving the rejection message and sending the request to restore the existing session with the second PDN gateway.

### BACKGROUND

Wireless communication systems are provided to facilitate network access to various devices, including user equipment (UEs). A wireless communication system can operate according to a wireless telecommunication standard, such a fourth generation (4G) long term evolution (LTE), fifth generation (5G) new radio (NR), etc., and can include a radio access network (RAN) to facilitate radio communications between devices and the network and a backend network including various nodes to manage device access. The various nodes can manage device access via the RAN portion of the wireless communication system that communicates with the device. The backend network nodes can include physical machines or corresponding functions managed over one or more physical machines. Examples of the backend network nodes can include a session management function (SMF), policy control function (PCF), user plane function (UPF), access and mobility management function (AMF) in 5G, mobility management entity (MME) in 4G, etc.

The SMF can support interworking of evolved packet system (EPS), for 4G, along with 5G core network (5GC). In this configuration, the SMF can act as a combined SMF and packet data network (PDN) gateway (PGW)-control plane (PGW-C) (SMF+PGW-C), and can communicate with a serving gateway (SGW) to receive 4G session creation requests from a MME. The PGW-C+SMF can forward communications between the MME (via a SGW) and PCF of a 5GC to provide the interworking of EPS and 5GC.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an example, a first packet data network (PDN) gateway is provided that includes one or more memories configured to, individually or in combination, store instructions, and one or more processors communicatively coupled with the one or more memories. The one or more processors are, individually or in combination, configured to execute the instructions to cause the first PDN gateway to receive, for a mobility management entity (MME) or evolved packet data gateway (ePDG), a request to restore an existing session with the first PDN gateway, receive, from a database and based on attempting to restore the existing session for the MME or ePDG, a read lock failure based on restoration of the existing session established for the MME or ePDG and a second PDN gateway, and send, for the MME or ePDG, a rejection message in response to the request, where the rejection message includes a cause code indicating to restore the existing session with the second PDN gateway.

In another example, a MME or ePDG is provided that includes one or more memories configured to, individually or in combination, store instructions, and one or more processors communicatively coupled with the one or more memories. The one or more processors are, individually or in combination, configured to execute the instructions to cause the MME or ePDG to send, to a first PDN gateway, a request to restore an existing session with the first PDN gateway, receive, for the first PDN gateway, a rejection message in response to the request, where the rejection message includes a cause code indicating to restore the existing session with a second PDN gateway, and send, to the second PDN gateway, and based on the rejection message, a second request to restore the existing session with the second PDN gateway.

In another example, a method for modifying a PDN gateway used for a session in wireless communications is provided that includes receiving, by a first PDN gateway and for a MME or ePDG, a request to restore an existing session with the first PDN gateway, receiving, by the first PDN gateway, from a database, and based on attempting to restore the existing session for the MME or ePDG, a read lock failure based on a restoration of the existing session established for the MME or ePDG and a second PDN gateway, and sending, by the first PDN gateway and for the MME or ePDG, a rejection message in response to the request, where the rejection message includes a cause code indicating to restore the existing session with the second PDN gateway.

In another example, a method for modifying a PDN gateway used for a session in wireless communications is provided that includes sending, by a MME or ePDG and to a first PDN gateway, a request to restore an existing session with the first PDN gateway, receiving, by the MME or ePDG and for the first PDN gateway, a rejection message in response to the request, where the rejection message includes a cause code indicating to restore the existing session with a second PDN gateway, and sending, by the MME or ePDG, to the second PDN gateway, and based on the rejection message, a second request to restore the existing session with the second PDN gateway.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram of an example of a wireless network, in accordance with aspects described herein.

FIG. 2 is a conceptual diagram of an example of a network including some nodes of a fifth generation core (5GC), in accordance with aspects described herein.

FIG. 3 is a flow diagram of an example of a method for rejecting a session creation request from a mobility management entity (MME), in accordance with aspects described herein.

FIG. 4 is a flow diagram of an example of a method for requesting restoration of a session with one or more packet data network (PDN) gateways, in accordance with aspects described herein.

FIG. 5 illustrates an example of a communications flow between various nodes of a 5GC, in accordance with aspects described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

This disclosure describes various examples related to collision handling for gateway sessions in wireless communications. In wireless communication technologies, such as fourth generation (4G) long term evolution (LTE) and/or fifth generation (5G) new radio (NR), various backend nodes can operate in conjunction with one another or provide access to a core wireless network for various devices, such as user equipment (UEs). Wireless access can be provided by a radio access network (RAN) and associated nodes of the wireless network, which may include one or more base stations (e.g., eNodeBs, Next Generation NodeBs (gNBs), etc.). The various backend nodes of a 5G core network (5GC) can include a session management function (SMF), which can manage communications between a device, such as a UE, and the wireless network via a base station or other RAN node, a policy control function (PCF), which can apply policy rules and service data flow detection, gating, quality-of-service (QoS), etc., a charging function (CHF) that performs traffic calculation and/or quota management for the 5GC, a user plan function (UPF) that manages traffic flows for the UE to route network traffic to the UE over corresponding bearers, etc. The 5GC can also include one more gateways that can facilitate access between the UEs and the SMF or other core network nodes, such as a packet data network (PDN) gateway (PGW), a serving gateway (SGW), etc. An evolved packet system (EPS) of a 4G core network can include other backend nodes, such as a mobility management entity (MME), which can facilitate access between 4G UEs and other core network nodes. In some examples, the SMF of a 5GC can provide interworking of EPS with the 5GC by implementing a combined SMF and PGW-control plane (PGW-C) (SMF+PGW-C), which can receive communications from a MME (e.g., via a SGW) and forward the communications to the PCF, or can receive communications from the PCF and forward the communications to the MME (e.g., via the SGW), etc. The core network nodes can operate on one or more servers or other devices.

In some cases, multiple PGWs (or PGW instances) can be deployed for redundancy, where each PGW can facilitate access between a MME and PCF (or other 5GC node). A session can be established between a MME and PCF via one PGW (e.g., a SMF+PGW-C instance) to provide interworking between the EPS associated with the MME and the 5GC. Where the PGW fails, the MME and/or PCF can initiate a restoration procedure to connect to a different PGW for the session. It is possible that the restoration procedures performed by the MME and PCF collide such that the PCF restores the session using a different PGW than the MME. Aspects described herein relate to handling such collisions so the MME and PCF (or other 5GC node) restore or otherwise establish the session with the same PGW instance. The aspects described herein, however, are not limited to this scenario and may be used in substantially any scenario where the MME sends a request to a PGW to create a session with a 5GC or corresponding node.

In accordance with some aspects described herein, a PGW instance can receive a request from a MME to create a session to restore the existing session with the PCF, which can be an interworking session with a 5GC. The PGW instance can attempt to create the session with the PCF (or other 5GC node), which can include the PGW instance accessing a database to indicate the PGW instance as associated with the session between the MME and PCF. In an example, where the PCF has performed a restoration procedure for the session with a different PGW instance, however, the querying PGW instance may receive an indication that the different PGW instance is associated with the session. In this example, the querying PGW instance can return a reject message to the MME, which can include a cause indicating that the MME is already associated with the different PGW instance. In this regard, for example, the MME can send the request to create the session to restore the existing session with the PCF with the different PGW instance so that the MME and PCF use the same PGW instance for communicating with one another.

In addition, though generally described in terms of an MME having a session with a PGW instance and PCF, in some examples, an evolved packet data gateway (ePDG) in 5G can similarly have a session with a PGW instance (or SMF+PGW-C instance). In such examples, the ePDG can employ aspects described of the MME herein to receive a reject message from one SMF+PGW-C instance in response to performing a restoration procedure, and accordingly restore the existing session with a different SMF+PGW-C instance.

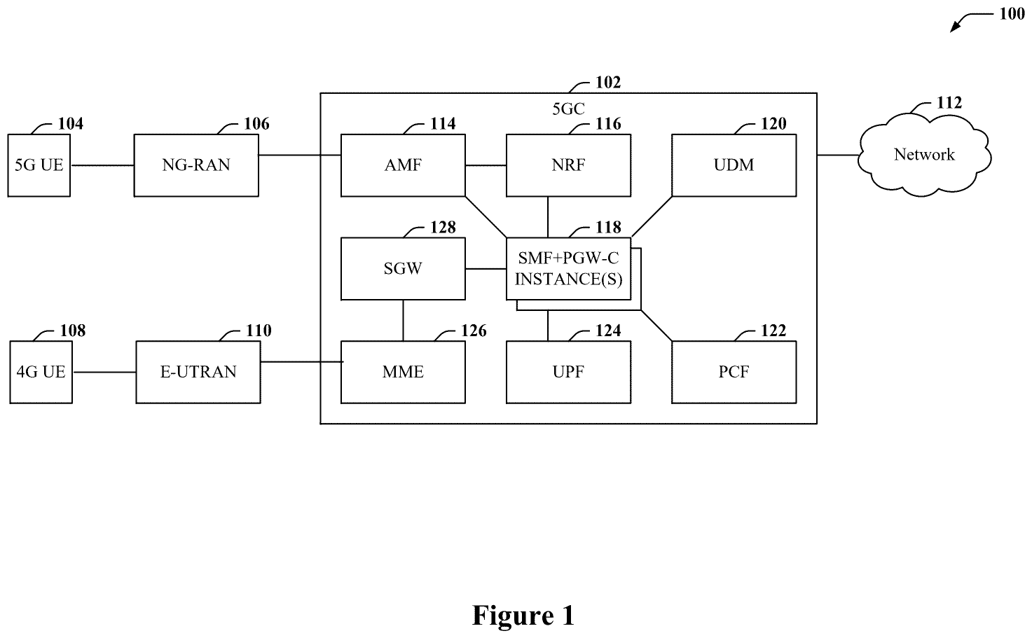

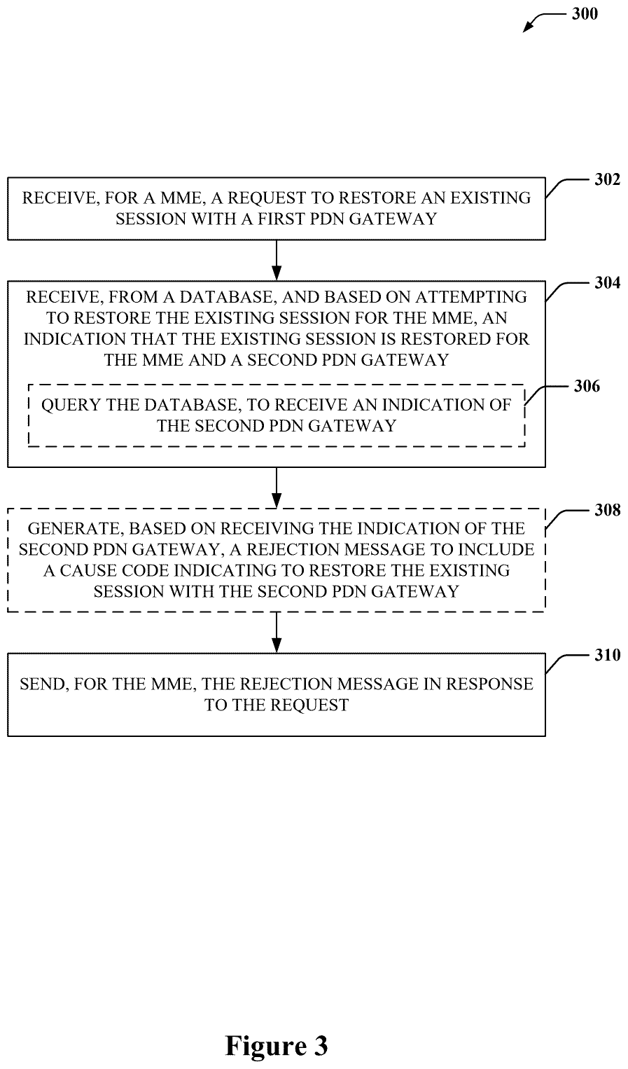

Turning now to FIGS. 1-5, examples are depicted with reference to one or more components and one or more methods that may perform the actions or operations described herein, where components and/or actions/operations in dashed line may be optional. Although the operations described below in FIGS. 3-5 are presented in a particular order and/or as being performed by an example component, the ordering of the actions and the components performing the actions may be varied, in some examples, depending on the implementation. Moreover, in some examples, one or more of the actions, functions, and/or described components may be performed by a specially-programmed processor, a processor executing specially-programmed software or computer-readable media, or by any other combination of a hardware component and/or a software component capable of performing the described actions or functions.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

FIG. 1 is a diagram of an example of a wireless network 100, in accordance with aspects described herein. For example, wireless network 100 may be a 5G NR network, which can include a 5GC 102, and a 5G UE 104 that can access the 5GC 102 via NG-RAN 106, where the NG-RAN 106 may include one or more gNBs or other radio access nodes with which the 5G UE 104 can wirelessly communicate to access the 5GC 102. For example, the 5GC 102 can also support interworking for 4G LTE components, and as such, a 4G UE 108 can also access the 5GC 102 via evolved universal mobile telecommunications system (UMTS) terrestrial RAN (E-UTRAN) 110, where the E-UTRAN 110 may include one or more eNodeBs or other radio access nodes with which the 4G UE 108 can wirelessly communicate to access the 5GC 102. The 5GC 102 can include various components to facilitate access to a network 112, which can be a network such as the Internet, or substantially any network.

For example, 5GC 102 can include a AMF 114 for providing quality-of-service (QoS) flows and session management for the 5G UE 104, a network function (NF) repository function (NRF) 116 for maintaining an updated record of NF status of various components of the 5GC 102, or one or more SMF+PGW-C instances 118 for providing both a SMF functionality for managing sessions between the 5G UE 104 and one or more components of the 5GC 102 (e.g., PCF) and providing a PGW-C functionality for supporting 4G communications between the 4G UE 108 and one or more components of the 5GC 102 (e.g., PCF). In one example, SMF+PGW-C instance 118 can facilitate access to the network 112 for 5G UE 104 and/or 4G UE 108. For example, 5GC 102 can also include unified data management (UDM) 120 for managing network user data in 5G, a PCF 122 for facilitating policy management and control in 5G, or a user plane function 124 for connecting data from the 5G UE 104, and/or 4G UE 108, to the network 112. The 5GC 102 may also include, or may be configured to communicate with, one or more components that support 4G interworking for 4G UEs 108, such as a MME 126 for managing mobility and identity of 4G Ues 108, and/or a SGW for facilitate communications between the MME 126 and one or more SMF+PGW-C instances 118.

In an example, the 5GC 102 can include multiple SMF+PGW-C instances 118, which can each execute on a server (e.g., a same or different server, a same or different collection of servers in a distributed computing or cloud-computing environment, etc.). The MME 126 can create a session with the PCF 122 (or other 5GC node) and at least one of the SMF+PGW-C instances 118 to allow the MME 126 to communicate with the PCF 122 to facilitate providing a 4G UE 108 with access to network 112 via the 5GC 102. The SMF+PGW-C instance 118 with which the session was created may fail, and the MME 126 and PCF 122 may separately detect the failure of this SMF+PGW-C instance 118. For example, PCF 122 can detect failure of at least the SMF function of the SMF+PGW-C instance 118 by receiving a notification from NRF 116 indicating the failure or other health status of the SMF+PGW-C instance 118. For example, MME 126 can detect failure of at least the PGW-C function of the SMF+PGW-C instance 118 based on detecting that a heartbeat message configured between the MME and PGW-C function is not received within a configured threshold period of time. In this example, the PCF 122 and MME 126 may separately perform restoration procedures to restore connection with a different SMF+PGW-C instance 118, and the restoration procedures may each select different SMF+PGW-C instance 118, which may lead to collision or conflict.

In accordance with aspects described herein, based on detecting failure of the SMF+PGW-C instance 118 (a first instance SMF+PGW-C instance) with which the original session with the MME 126 was created, the PCF 122 can perform the restoration procedure to associate the session with a different selected SMF+PGW-C instance 118 (a second SMF+PGW-C instance). The MME 126, upon detecting failure of the original SMF+PGW-C instance 118, can subsequently attempt to restore the existing session with a different SMF+PGW-C instance 118 other than the one selected by the PCF 122 (a third SMF+PGW-C instance) by sending a session creation request to the third SMF+PGW-C instance. The third SMF+PGW-C instance can determine that the session is associated with the second SMF+PGW-C instance, which may be based on the third SMF+PGW-C instance querying a database that stores session information regarding which SMF+PGW-C instance is associated with which session between MME and PCF. Based on this determination, the third SMF+PGW-C instance can reject the session creation request from the MME 126 and can include a cause code in a rejection message indicating that the MME 126 should send the session creation request to a different SMF+PGW-C instance (e.g., the second SMF+PGW-C instance). Based on receiving the rejection with the indicator, MME 126 can then send the session creation request to the second SMF+PGW-C instance, which can associate the MME 126 with the session with the PCF 122, thus restoring the existing session with the same SMF+PGW-C used by the PCF 122.

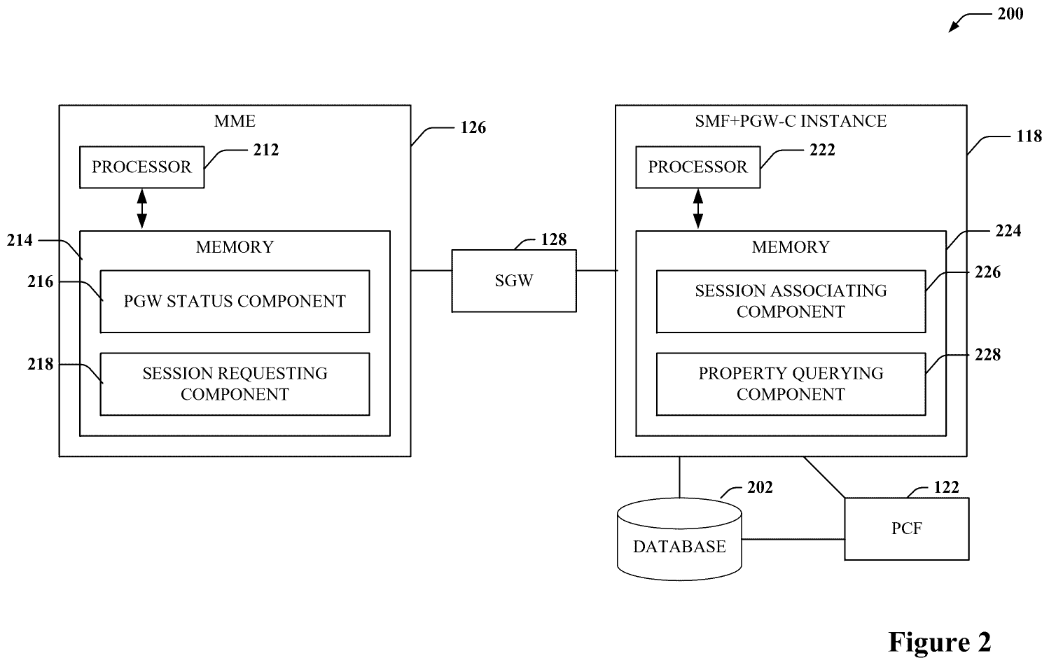

FIG. 2 is a conceptual diagram of an example of a network 200 including some nodes of a 5GC, in accordance with aspects described herein. Network 200 includes a MME 126 that can communicate with a SMF+PGW-C instance 118, or at least a PGW-C function thereof, via SGW 128, to create a session for communicating with a PCF 122 or other 5GC node. Network 200 can also include a database 202 that can store and/or manage session information for sessions created between MMEs, SMF+PGW-C instances, and PCFs (or other 5GC nodes). In one example, database 202 can include a locking mechanism to allow for locking tables or rows of data in the database 202. In this regard, in an example, a SMF+PGW-C instance can write session information to the database 202 and can lock the table or row from being updated by another SMF+PGW-C instance.

In an example, MME 126 can include a processor 212 and/or memory 214, or can be part of a computing device (e.g., server) including the processor 212 and/or memory 214, configured to execute or store instructions or other parameters related to performing one or more functions of the MME 126 described herein. For example, processor 212 and/or memory 214 can be configured to execute or store instructions or other parameters related to providing a PGW status component 216 for determining a status of a PGW function or instance (e.g., of a SMF+PGW-C instance, as described herein), and/or a session requesting component 218 for requesting creation of session with a PGW function of instance (e.g., of a SMF+PGW-C instance, as described herein) for accessing a 5GC node, such as PCF 122. For example, processor 212 and memory 214 may be separate components communicatively coupled by a bus (e.g., on a motherboard or other portion of a computing device, on an integrated circuit, such as a system on a chip (SoC), etc.), components integrated within one another (e.g., processor 212 can include the memory 214 as an on-board component), and/or the like. Memory 214 may store instructions, parameters, data structures, etc. for use/execution by processor 212 to perform functions described herein.

In an example, SMF+PGW-C instance 118 can include a processor 222 and/or memory 224, or can be part of a computing device (e.g., server) including the processor 222 and/or memory 224, configured to execute or store instructions or other parameters related to performing one or more functions of the SMF+PGW-C instance 118 described herein. For example, processor 222 and/or memory 224 can be configured to execute or store instructions or other parameters related to providing a session associating component 226 for creating a session for a MME 126 and a 5GC node (e.g., PCF122) and/or storing session information for the session, and/or a property querying component 228 for querying a database 202 for session information or properties for one or more sessions or corresponding nodes (e.g., MME 126, PCF 122, etc.). In some examples, as described above, communications between MME 126 and SMF+PGW-C instance 118 can traverse a SGW 128.

In an example, session requesting component 218 can send a session creation request to an initial SMF+PGW-C instance (not shown) to create a session for communicating with PCF 122. In this example, session associating component 226 can receive the request, create the session (e.g., establish parameters, flows, etc. for the session), and/or can store session information in the database 202 indicating the session and the corresponding nodes (e.g., MME 126, the initial SMF+PGW-C instance, and/or PCF 122, etc.). In one example, the initial SMF+PGW-C instance (the first SMF+PGW-C instance) can fail, in which case the PCF 122 can receive a notification of the failure (e.g., from an NRF, as described), and can restore the session with a different SMF+PGW-C instance (the second SMF+PGW-C instance). In addition, PGW status component 216 can receive or subscribe to heartbeat messages sent by the initial SMF+PGW-C instance, and can detect the failure based on determining that a heartbeat message is not received within a threshold period of time, or based on attempting to communicate with the initial SMF+PGW-C instance without receiving a response, etc.

When the PGW status component 216 detects that the initial SMF+PGW-C instance has failed, session requesting component 218 can send a session creation request to another SMF+PGW-C instance 118 (the third SMF+PGW-C instance), which may be different than the second SMF+PGW-C instance with which the PCF 122 restored the session, to restore the existing session that was previously established on the first SMF+PGW-C. Session associating component 226 of SMF+PGW-C instance 118 can receive the session creation request from the MME 126 (e.g., via SGW 128). In one example, session associating component 226 can attempt to associate a new session with the MME 126, SMF+PGW-C instance 118, and PCF 122 by storing associated session information in the database 202, and may encounter a read lock failure on a table or row associated with sessions for the MME 126 and/or PCF 122, which was set by the second SMF+PGW-C instance. In this example, or without first attempting to write the session information, property querying component 228 may query the database 202 to obtain any session information for the MME 126 and/or PCF 122 that may exist in the database 202, and may accordingly determine a different SMF+PGW-C instance (e.g., the second SMF+PGW-C instance) that is associated with the session for the MME 126 and PCF 122.

In this example, session associating component 226 can reject the session creation request from the MME 126, which can include sending a session creation rejection message to the MME 126 (e.g., via SGW 128). The session creation rejection message can include a cause code indicating that the MME 126 instead send the session creation request to the different SMF+PGW-C instance (e.g., the second SMF+PGW-C instance) that is associated with the session for the MME 126 and PCF 122. In one example, the rejection message can include an indication of the different SMF+PGW-C instance (e.g., the second SMF+PGW-C instance) that is associated with the session for the MME 126 and PCF 122. In another example, the MME 126 can have, in the meantime, received a create bearer message from the different SMF+PGW-C instance (e.g., the second SMF+PGW-C instance) (e.g., as part of the PCF 122 updating the SMF+PGW-C instance for the session). In any case, for example, session requesting component 218 can receive the session creation rejection message, and can accordingly identify the different SMF+PGW-C instance to which to send the session creation request and/or the cause to send the session creation request. Session requesting component 218 can accordingly send the session creation request to the different SMF+PGW-C instance (e.g., the second SMF+PGW-C instance) that is associated with the session for the MME 126 and PCF 122, and the different SMF+PGW-C instance can restore the existing session for the MME 126.

FIG. 3 is a flowchart of an example of a method 300 for rejecting a session creation request from a MME, in accordance with aspects described herein. For example, method 300 can be performed by a SMF+PGW-C instance 118, or at least a PGW function thereof, as described herein.

In method 300, at action 302, a request to restore an existing session with a first PDN gateway can be received for a MME (or ePDG, as described). In an example, session associating component 226, e.g., in conjunction with processor 222, memory 224, etc., can receive, for the MME (e.g., MME 126), the request to restore the existing session with the first PDN gateway. In this example, the first PDN gateway can include the SMF+PGW-C instance 118, or at least a PGW function thereof, with which the MME 126 is requesting to create the session (e.g., to restore the existing session) for communicating with a 5GC node (e.g., PCF 122). Thus, in this example, the 5GC node (e.g., PCF 122) can have restored a session with a different SMF+PGW-C instance (a second SMF+PGW-C instance) after detecting failure of yet another SMF+PGW-C instance (a third SMF+PGW-C instance). In one example, the first PDN gateway (SMF+PGW-C instance 118, or at least a PGW function thereof) can receive the request via a SGW.

In method 300, at action 304, an indication that an existing session is restored for the MME and a second PDN gateway can be received from a database and based on attempting to restore the existing session for the MME. In an example, session associating component 226, e.g., in conjunction with processor 222, memory 224, etc., can receive, from the database (e.g., database 202), and based on attempting to restore the existing session for the MME (e.g., MME 126), the indication that the existing session is restored for the MME and a second PDN gateway (e.g., a different SMF+PGW-C instance—the second SMF+PGW-C instance).

In an example, receiving the indication at action 304, optionally at action 306, the database can be queried to receive an indication of the second PDN gateway. In an example, property querying component 228, e.g., in conjunction with processor 222, memory 224, etc., can query the database (e.g., database 202) to receive the indication of the second PDN gateway. In one example, property querying component 228 can query the database to determine if the MME 126 and/or second PDN gateway are associated with a session already before session associating component 226 attempts to restore the existing session or write corresponding information to the database 202. In another example, session associating component 226 can encounter a database read lock failure when attempting to write session information to a table or row associated with the MME 126 or PCF 122, and may accordingly query the database to determine the PDN gateway indicated in the session information already established for the MME 126 (e.g., the session information for the existing session). As described, for example, the PCF 122 may have already restored the session (or created a new session) for the MME 126 and PCF 122 with the second PDN gateway. When the property querying component 228 identifies the session information for the existing session indicating that the MME 126 and PCF 122 are associated with a different PDN gateway (the second PDN gateway), session associating component 226 can include this information in a rejection message.

In method 300, optionally at action 308, a rejection message can be generated, based on receiving the indication of the second PDN gateway, to include a cause code indicating to restore the existing session with the second PDN gateway. In an example, session associating component 226, e.g., in conjunction with processor 222, memory 224, etc., can generate, based on receiving the indication of the second PDN gateway, the rejection message to include the cause code indicating to restore the existing session with the second PDN gateway. In addition, in one example, session associating component 226 can generate the rejection message to include an indication or identifier of the PDN gateway.

In method 300, at action 310, the rejection message can be sent, for the MME, in response to the request. In an example, session associating component 226, e.g., in conjunction with processor 222, memory 224, etc., can send, for the MME (e.g., MME 126), the rejection message in response to the request. For example, session associating component 226 can send the rejection message to the MME 126 via SGW 128, and the rejection message can identify the second PDN gateway (e.g., the second SMF+PGW-C instance or PGW function thereof) and/or a cause code to cause the MME 126 to request session creation with the second PDN gateway. The MME 126 can accordingly send the session creation request to the second PDN gateway.

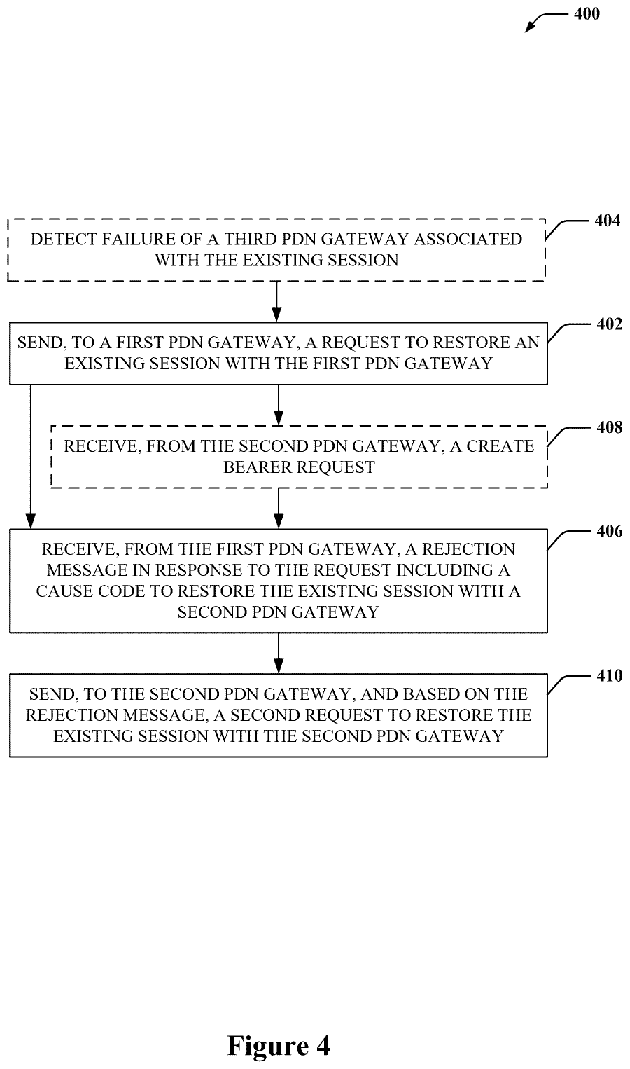

FIG. 4 is a flowchart of an example of a method 400 for requesting restoration of a session with one or more PDN gateways, in accordance with aspects described herein. For example, method 400 can be performed by a MME 126 (or ePDG), as described herein.

In method 400, at action 402, a request to restore an existing session with a first PDN gateway can be sent to the first PDN gateway. In an example, session requesting component 218, e.g., in conjunction with processor 212, memory 214, etc., can send, to the first PDN gateway (e.g., SMF+PGW-C instance 118 or at least a PGW function thereof), the request to restore the existing session with the first PDN gateway. For example, session requesting component 218 can send the request via SGW 128. Session requesting component 218 can send the request based on detecting failure of a PDN gateway associated with a previous session (the existing session) with the MME 126 and a 5GC node (e.g., PCF 122). In addition, the 5GC node (e.g., PCF 122) may have restored the existing session with another PDN gateway (a second PDN gateway).

In method 400, optionally at action 404, failure of a third PDN gateway associated with the existing session can be detected. In an example, PGW status component 216, e.g., in conjunction with processor 212, memory 214, etc., can detect failure of the third PDN gateway associated with the existing session. For example, PGW status component 216 can request or otherwise subscribe to heartbeat messages from the PDN gateway associated with the previous session (the third PDN gateway) to ensure the PDN gateway is properly functioning. In an example, PGW status component 216 can detect failure of the third PDN gateway based on detecting that a heartbeat message is not received within a threshold period of time. In any case, as described, session requesting component 218 can request restoration of the session with a different PDN gateway (first PDN gateway—SMF+PGW-C instance 118 or at least a PGW function thereof) based on detecting failure of the third PDN gateway.

In method 400, at action 406, a rejection message can be received, from the first PDN gateway, in response to the request, where the rejection message includes a cause code to restore the existing session with the second PDN gateway. In an example, session requesting component 218, e.g., in conjunction with processor 212, memory 214, etc., can receive, from the first PDN gateway (e.g., SMF+PGW-C instance 118 or at least a PGW function thereof) the rejection message in response to the request, as described above, and the rejection message can include the cause code indicating to restore the existing session by sending the session creation request to the second PDN gateway. In one example, as described, the rejection message can include the identifier of the second PDN gateway with which the 5GC node (e.g., PCF 122) already restored the session (or created a new session) for the MME 126 and 5GC node.

In another example, in method 400, optionally at action 408, a create bearer request can be received from the second PDN gateway. In an example, session requesting component 218, e.g., in conjunction with processor 212, memory 214, etc., can receive, from the second PDN gateway (e.g., via SGW 128) the create bearer request. For example, the second PDN gateway can send to create bearer request to the MME 126 based on the PCF 122 updating the session to use the second PDN gateway, so the second PDN gateway can establish the bearer with the MME 126 to facilitate communications between the MME 126 and 5GC nodes. In this example, session requesting component 218 can identify the second PDN gateway to which to send the create session request message to restore the session based on receiving the create bearer request therefrom.

In method 400, at action 410, a second request to restore the existing session with the second PDN gateway can be sent to the second PDN gateway and based on the rejection message. In an example, session requesting component 218, e.g., in conjunction with processor 212, memory 214, etc., can send, to the second PDN gateway, and based on the rejection message, the second request to restore the existing session with the second PDN gateway to restore the existing session with the PCF 122.

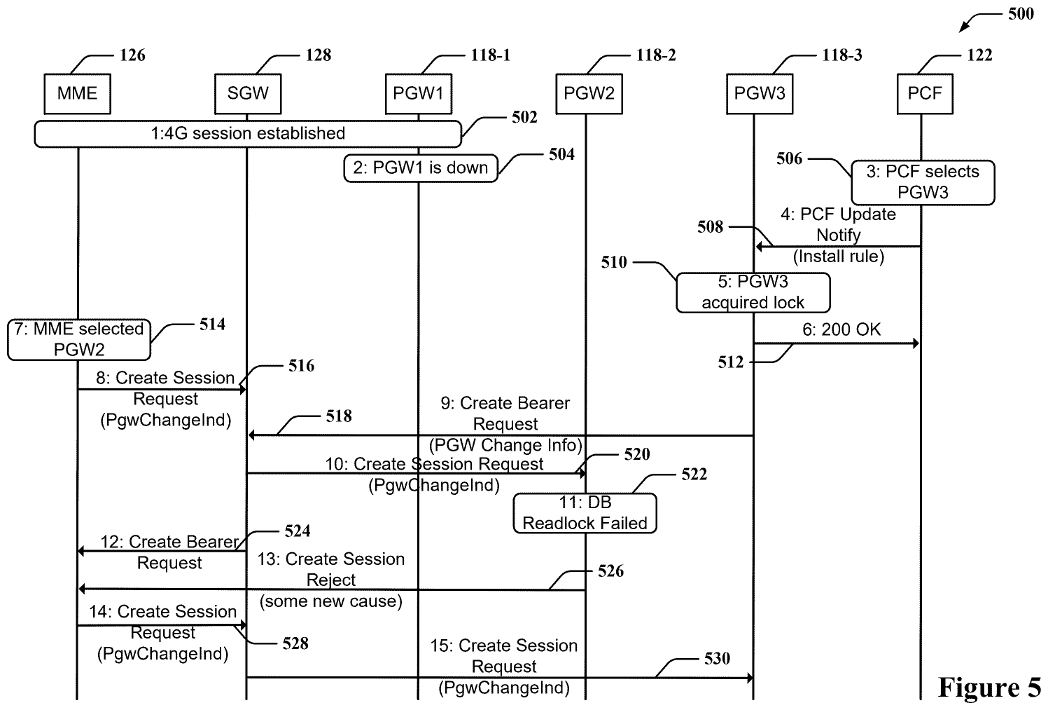

FIG. 5 illustrates an example of a communications flow 500 between various nodes of a 5GC, in accordance with aspects described herein. Communications flow 500 can include communications between a MME 126 (or ePDG, as described), SGW 128, a first PGW instance (PGW1) 118-1, a second PGW instance (PGW2) 118-2, a third PGW instance (PGW3) 118-3, and a PCF 122. At 502, the MME 126 can establish a 4G session with PGW1 1181 for accessing nodes of the 5GC, such as PCF 122. At 504, PGW1 118-1 can go down (e.g., can fail), such that it cannot provide MME 126 with functionality for communicating with the 5GC. At 506, the PCF 122 can select a new PGW3 118-3, which can be based on PCF 122 detecting that PGW1 118-1 is down (e.g., such as by receiving a notification from NRF that PGW1 118-1 is down). At 508, PCF 122 can send a PCF update notify to PGW3 118-3 to associate PGW3 118-3 with the session with MME 126 (e.g., cause the previous session to be restored for PCF 122 with the PGW3 118-3). At 510, PGW3 118-3 can acquire a database lock, which may include publishing session information to the database to identify the PCF 122, MME 126, and/or PGW3 118-3 as associated with the session and locking the corresponding table or row from being written by another PGW. At 512, PGW3 118-3 can send an acknowledgement to the PCF 122 that the PGW has been updated for the session.

At 514, the MME can select a new PGW2 118-2, which can be based on the MME 126 detecting that PGW 118-1 is down (e.g., such as by determining that a heartbeat message is not received from PGW 118-1 within a threshold period of time), and MME 126 can send a Create Session Request to the SGW 128, for forwarding to PGW2 118-2, at 516, to restore the existing session. In the meantime, at 518, PGW3 118-3 can send a Create Bearer Request to SGW 128 for MME 126 requesting to create a bearer for communicating with MME 126. SGW 128 can forward the Create Session Request from the MME 126 to PGW2 118-2 at 520. PGW2 118-2, as part of trying to restore the session for MME 126, can encounter a database read lock failure at 522. SGW 128 can forward the Create Bearer Request from PGW3 118-3 to MME 126 at 524. Based on the read lock failure, PGW2 118-2 can send a Create Session Reject to the MME 126 at 526, where the Create Session Reject can indicate a cause code and/or an identifier of PGW3 118-3. MME 126 can receive the Create Session Reject and accordingly send a Create Session Request to SGW 128 indicating PGW3 118-3 at 528, to restore the existing session with PCF 122 and PGW3 118-3. SGW 128 can forward the Create Session Request to PGW3 118-3 at 530 so the MME 126 can associate with the same PGW3 118-3 as PCF 122 for the session.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, one or more of the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more. ” Unless specifically stated otherwise, the term “some” refers to one or more. All structural and functional equivalents to the elements of the various aspects described herein that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for. ”

What is claimed is:

1. A mobility management entity (MME) or evolved packet data gateway (ePDG), comprising:
one or more memories configured to, individually or in combination, store instructions; and
one or more processors communicatively coupled with the one or more memories, wherein the one or more processors are, individually or in combination, configured to execute the instructions to cause the MME or ePDG to:
send, to a first packet data network (PDN) gateway, a request to restore an existing session with the first PDN gateway;
receive, for the first PDN gateway, a rejection message in response to the request, wherein the rejection message includes a cause code indicating to restore the existing session with a second PDN gateway; and
send, to the second PDN gateway, and based on the rejection message, a second request to restore the existing session with the second PDN gateway.

2. The MME or ePDG of claim 1, wherein the one or more processors are, individually or in combination, configured to execute the instructions to cause the first PDN gateway to send the request to restore the existing session with the first PDN gateway based on detecting failure of a third PDN gateway associated with the MME or ePDG.

3. The MME or ePDG of claim 1, wherein the one or more processors are, individually or in combination, configured to execute the instructions to cause the first PDN gateway to receive, for the second PDN gateway, a create bearer request, wherein the one or more processors are, individually or in combination, configured to execute the instructions to cause the first PDN gateway to send the second request to the second PDN gateway based on receiving the create bearer request.

4. The MME or ePDG of claim 1, wherein the rejection message includes an identifier of the second PDN gateway.

5. The MME or ePDG of claim 1, wherein the one or more processors are, individually or in combination, configured to execute the instructions to cause the first PDN gateway to send the request includes sending the request for the MME or ePDG to a serving gateway (SGW) for forwarding to the first PDN gateway, and wherein the one or more processors are, individually or in combination, configured to execute the instructions to cause the first PDN gateway to receive the rejection message at least in part by receiving the rejection message for the MME or ePDG from the first PDN gateway via the SGW.

6. A first packet data network (PDN) gateway, comprising:
one or more memories configured to, individually or in combination, store instructions; and
one or more processors communicatively coupled with the one or more memories, wherein the one or more processors are, individually or in combination, configured to execute the instructions to cause the first PDN gateway to:
receive, for a mobility management entity (MME) or evolved packet data gateway (ePDG), a request to restore an existing session with the first PDN gateway;
receive, from a database and based on attempting to restore the existing session for the MME or ePDG, a read lock failure based on restoration of the existing session established for the MME or ePDG and a second PDN gateway; and
send, for the MME or ePDG, a rejection message in response to the request, wherein the rejection message includes a cause code indicating to restore the existing session with the second PDN gateway.

7. The first PDN gateway of claim 6, wherein the one or more processors are, individually or in combination, configured to execute the instructions to cause the first PDN gateway to:
query the database, based on receiving the read lock failure, to receive an indication of the second PDN gateway; and
generate, based on receiving the indication of the second PDN gateway, the rejection message to include an identifier of the second PDN gateway.

8. The first PDN gateway of claim 6, wherein receiving the request includes receiving the request for the MME or ePDG from a serving gateway (SGW), and wherein sending the rejection message includes sending the rejection message for the MME or ePDG to the SGW.

9. The first PDN gateway of claim 6, wherein receiving the request to restore the existing session is based on a failure of a third PDN gateway associated with the existing session established for the MME or ePDG.

10. A method for modifying a packet data network (PDN) gateway used for a session in wireless communications, comprising:
sending, by a mobility management entity (MME) or evolved packet data gateway (ePDG) and to a first PDN gateway, a request to restore an existing session with the first PDN gateway;
receiving, by the MME or ePDG and for the first PDN gateway, a rejection message in response to the request, wherein the rejection message includes a cause code indicating to restore the existing session with a second PDN gateway; and
sending, by the MME or ePDG, to the second PDN gateway, and based on the rejection message, a second request to restore the existing session with the second PDN gateway.

11. The method of claim 10, wherein sending the request to restore the existing session with the first PDN gateway is based on detecting failure of a third PDN gateway associated with the MME or ePDG.

12. The method of claim 10, further comprising receiving, for the second PDN gateway, a create bearer request, wherein sending the second request to the second PDN gateway is based on receiving the create bearer request.

13. The method of claim 10, wherein the rejection message includes an identifier of the second PDN gateway.

14. The method of claim 10, wherein sending the request includes sending the request for the MME or ePDG to a serving gateway (SGW) for forwarding to the first PDN gateway, and wherein receiving the rejection message includes receiving the rejection message for the MME or ePDG from the first PDN gateway via the SGW.

15. The method of claim 10, wherein a policy control function (PCF), user data management (UDM), charging function (CHF), or user plane function (UPF) restores the existing session for the MME or ePDG and the second PDN gateway.

16. A method for modifying a packet data network (PDN) gateway used for a session in wireless communications, comprising:
receiving, by a first PDN gateway and for a mobility management entity (MME) or evolved packet data gateway (ePDG), a request to restore an existing session with the first PDN gateway;
receiving, by the first PDN gateway, from a database, and based on attempting to restore the existing session for the MME or ePDG, a read lock failure based on a restoration of the existing session established for the MME or ePDG and a second PDN gateway; and
sending, by the first PDN gateway and for the MME or ePDG, a rejection message in response to the request, wherein the rejection message includes a cause code indicating to restore the existing session with the second PDN gateway.

17. The method of claim 16, further comprising:
querying the database, based on receiving the read lock failure, to receive an indication of the second PDN gateway; and
generating, based on receiving the indication of the second PDN gateway, the rejection message to include an identifier of the second PDN gateway.

18. The method of claim 16, wherein receiving the request includes receiving the request for the MME or ePDG from a serving gateway (SGW), and wherein sending the rejection message includes sending the rejection message for the MME or ePDG to the SGW.

19. The method of claim 16, wherein receiving the request to restore the existing session is based on a failure of the exsiting session established for the MME or ePDG and a third gateway.

20. The method of claim 16, wherein a policy control function (PCF), user data management (UDM), charging function (CHF), or user plane function (UPF) restores the existing session for the MME or ePDG and the second PDN gateway.
